(19) United States
(12) Patent Application Publication
(10) Pub. No.: US 2024/0217590 A1
(43) Pub. Date: Jul. 4, 2024

(54) Hard Floor Structure for Vehicle

(71) Applicants: Hyundai Motor Company, Seoul (KR); Kia Corporation, Seoul (KR)

(72) Inventors: Chun Gyun Oh, Seoul (KR); Hyo Keun Kim, Suwon-si (KR); Hyo Chul Myoung, Suwon-si (KR); Chang Mo Seong, Suwon-si (KR)

(21) Appl. No.: 18/364,043

(22) Filed: Aug. 2, 2023

(30) Foreign Application Priority Data
Dec. 28, 2022 (KR) 10-2022-0186524

(51) Int. Cl. B62D 25/20

(52) U.S. Cl. CPC B62D 25/20

(57) ABSTRACT

An embodiment hard floor structure for a vehicle includes a bracket unit fastened to a floor panel and a hard cover unit on the bracket unit, the hard cover unit being exposed to an interior of the vehicle and having a plate shape. In an embodiment, the bracket unit includes a first bracket in a region corresponding to a driver seat, a second bracket in a region corresponding to a front passenger seat, a third bracket in a region corresponding to a passenger seat behind the driver seat, and a fourth bracket in a region corresponding to a passenger seat behind the front passenger seat.

### CROSS-REFERENCE TO RELATED APPLICATIONS

This application claims the benefit of Korean Patent Application No. 10-2022-0186524, filed on Dec. 28, 2022, which application is hereby incorporated herein by reference.

### TECHNICAL FIELD

The present invention relates to a hard floor structure for a vehicle.

### BACKGROUND

A chassis, a frame for a vehicle structure, is changing and being developed into a form in which a subframe configured to increase torsional rigidity is attached to a body or various accessories are attached to a body made of various materials and shapes so as to reduce weight. The vehicle chassis is a portion excluding the body (vehicle body), which is a general term for main components including a power system (powertrain), a steering system, a suspension, a driveshaft, and a frame configured to support the same.

All of the above components are structures developed according to the characteristics of an internal combustion engine and are based on a fossil fuel energy source and a power system (powertrain) such as an engine, a reducer, and a clutch as a power source. As described above, due to the shape of the chassis including the power system, the floor panel and the floor mat structure surrounding the panel in the interior of the vehicle inevitably include curves.

However, in recent years, research on a power engine using a battery has continued, and an autonomous driving environment using a lidar, a camera, etc. during traveling of a vehicle is being developed. Due to the development of autonomous driving technology, the selling point of the vehicle is expected to be focused on “convenience and comfort while on board” rather than “joy of driving” or “traveling performance.” Accordingly, in order to provide a vehicle interior space with various conveniences, a floor structure having a plate shape is desired.

The above information disclosed in this background section is only for enhancement of understanding of the background of embodiments of the invention, and therefore it may contain information that does not form the prior art that is already known to a person of ordinary skill in the art.

Korean Patent Publication No. 10-2017-0089328 may provide information related to background information for embodiments of the present invention.

### SUMMARY

The present invention relates to a hard floor structure for a vehicle. Particular embodiments relate to a hard floor structure for a vehicle capable of providing a plate-shaped flat floor structure by providing a hard cover unit constituting the floor of the vehicle.

Embodiments of the present invention can solve problems associated with the prior art, and an embodiment of the present invention provides a flat floor by providing a plate-shaped hard cover unit.

Another embodiment of the present invention provides a hard cover unit including cover cells and provides a hard floor structure for a vehicle including units positioned between the cover cells and configured to perform various functions.

The embodiments of the present invention are not limited to the above-mentioned embodiments, and other embodiments of the present invention not mentioned herein may be understood based on the following description and may be understood more clearly through the described embodiments of the present invention. In addition, the embodiments of the present invention may be realized by means and combinations thereof indicated in the claims.

One embodiment of the present invention provides a hard floor structure for a vehicle, the hard floor structure including a bracket unit fastened to a floor panel, a sound absorbing material positioned between the bracket unit and the floor panel, and a hard cover unit, located on the upper end of the bracket unit, exposed to the interior of the vehicle, and having a plate shape.

In a preferred embodiment, the bracket unit may include a first bracket located in a region corresponding to a driver seat, a second bracket located in a region corresponding to a front passenger seat, a third bracket located in a region corresponding to a passenger seat behind the driver seat, and a fourth bracket located in a region corresponding to a passenger seat behind the front passenger seat.

In another preferred embodiment, the first bracket and the second bracket each may have at least a portion overlapping each other at a position where the same are fastened to the floor panel.

In still another preferred embodiment, the third bracket and the fourth bracket each may have at least a portion fixed to each other.

In yet another preferred embodiment, the first bracket and the third bracket each may have at least a portion overlapping each other at a position where the same are fastened to the floor panel.

In still yet another preferred embodiment, the second bracket and the fourth bracket each may have at least a portion overlapping each other at a position where the same are fastened to the floor panel.

In a further preferred embodiment, the hard cover unit may further include a center molding inserted into a center groove formed between the first bracket and the second bracket.

In another further preferred embodiment, the hard cover unit may further include an end cover inserted into an end groove formed between the first bracket and the second bracket located at a front seat and the third bracket and the fourth bracket located at a rear seat.

In still another further preferred embodiment, the hard cover unit may include a combination of a plurality of cover cells.

In yet another further preferred embodiment, the hard floor structure may further include at least one lamp unit, located in a gap between the plurality of cover cells and inserted into at least one groove formed in the bracket unit.

In still yet another further preferred embodiment, the hard cover unit may have at least a portion configured to cover the upper end of the lamp unit.

In a still further preferred embodiment, the hard floor structure may further include a seat rail unit fixed to the floor panel and protruding through the upper end of the hard cover unit.

In still another further preferred embodiment, the seat rail unit may include a lower rail fixed to the floor panel, an upper rail having one end positioned in the lower rail, having another end protruding through the hard cover unit in the height direction of the hard cover unit, and configured to move along a longitudinal transfer groove formed in the hard cover unit, and a cover portion located on the rear surface of the hard cover unit and configured to cover the transfer groove along the movement trajectory of the upper rail.

In a yet still further preferred embodiment, the seat rail unit may include a lower rail fixed to the floor panel, a monopost rail having one end positioned in the lower rail, having another end protruding through the hard cover unit in the height direction of the hard cover unit, and configured to move, and a covering located on the rear surface of the hard cover unit and configured to move integrally with the monopost rail.

In yet another still further preferred embodiment, at least a portion of the upper surface of the hard cover unit may be positioned to overlap a door scuff.

Another embodiment of the present invention provides a hard floor structure for a vehicle, the hard floor structure including a bracket unit fastened to a floor panel, a sound absorbing material positioned between the bracket unit and the floor panel, and a hard cover unit located on the upper end of the bracket unit and having a plate shape in which a plurality of cover cells is arranged.

In a preferred embodiment, the hard floor structure may further include at least one lamp unit located in a gap between the plurality of cover cells and inserted into at least one groove formed in the bracket unit.

In another preferred embodiment, the hard cover unit may have at least a portion configured to cover the upper end of the lamp unit.

In still another preferred embodiment, at least one of the plurality of cover cells may include a pressure sensor configured to drive the lamp unit.

In yet another preferred embodiment, the hard floor structure may further include a seat rail unit fixed to the floor panel and protruding through the upper end of the hard cover unit.

Other aspects and preferred embodiments of the invention are discussed infra.

It is to be understood that the term “vehicle” or “vehicular” or other similar terms as used herein are inclusive of motor vehicles in general, such as passenger automobiles including sport utility vehicles (SUVs), buses, trucks, various commercial vehicles, watercraft including a variety of boats and ships, aircraft, and the like, and include hybrid vehicles, electric vehicles, plug-in hybrid electric vehicles, hydrogen-powered vehicles, and other alternative fuel vehicles (e.g., fuels derived from resources other than petroleum). As referred to herein, a hybrid vehicle is a vehicle that has two or more sources of power, for example, a vehicle powered by both gasoline and electricity.

The above and other features of embodiments of the invention are discussed infra.

### BRIEF DESCRIPTION OF THE DRAWINGS

The above and other features of embodiments of the present invention will now be described in detail with reference to certain exemplary embodiments thereof illustrated in the accompanying drawings which are given hereinbelow by way of illustration only and thus are not limitative of the present invention, and wherein:

FIG. 1 illustrates how a hard floor structure for a vehicle is constructed, as one embodiment of the present invention;

FIG. 2 is a cross-sectional side view of a hard floor structure for a vehicle, as one embodiment of the present invention;

FIG. 3A is a top view of a hard floor structure for a vehicle, as one embodiment of the present invention;

FIG. 3B is a side view of a structure in which a first bracket and a second bracket of a hard floor structure for a vehicle are fastened to each other, as one embodiment of the present invention;

FIG. 3C is a side view of a structure in which a third bracket and a fourth bracket of a hard floor structure for a vehicle are fastened to each other, as one embodiment of the present invention;

FIG. 3D is a side view of a structure in which a second bracket and a fourth bracket of a hard floor structure for a vehicle are fastened to each other, as one embodiment of the present invention;

FIG. 4 is a cross-sectional side view of a lamp unit provided between cover cells, as one embodiment of the present invention;

FIG. 5 is a cross-sectional view of a hard floor structure for a vehicle in which a seat rail unit is located, as one embodiment of the present invention; and

FIG. 6 is a cross-sectional view of a hard floor structure for a vehicle in which a seat rail unit is located, as another embodiment of the present invention.

It should be understood that the appended drawings are not necessarily to scale, presenting a somewhat simplified representation of various preferred features illustrative of the basic principles of embodiments of the invention. The specific design features of embodiments of the present invention as disclosed herein, including, for example, specific dimensions, orientations, locations, and shapes, will be determined in part by the particular intended application and usage environment.

In the figures, reference numbers refer to the same or equivalent parts of embodiments of the present invention throughout the several figures of the drawings.

### DETAILED DESCRIPTION OF ILLUSTRATIVE EMBODIMENTS

Hereinafter, embodiments of the present invention will be described in detail with reference to the accompanying drawings. The embodiments of the present invention may be modified into various forms, and the scope of embodiments of the present invention should not be construed as being limited to the following embodiments. The embodiments are provided to more completely explain features of the present invention to those skilled in the art.

In addition, terms such as “ . . . portion,” “ . . . unit,” “ . . . module,” etc. used in this specification each refer to a unit that processes at least one function or operation and may be implemented as hardware, software, or a combination thereof.

The terminology used herein is for the purpose of describing particular embodiments only and is not intended to be limiting. A singular representation may include a plural representation unless it represents a definitely different meaning from the context.

It will be understood that, although the terms “first,” “second,” etc. may be used herein to describe various similar elements, these elements should not be construed as being limited by these terms. These terms are only used to distinguish one element from another.

In addition, in this specification, “driver seat” means one end close to one side of a front seat, and “front passenger seat” means a position close to another end far from the one end where the driver seat is located in the front seat.

Various embodiments in this specification are described with reference to the accompanying drawings. Examples and terms used herein are not intended to limit the technology described in this specification and are not limited to particular embodiments, but should be understood as including various modifications, equivalents, and/or alternatives. In the description of the drawings, the same/like reference numerals may be used for the same/like components. A singular representation may include a plural representation unless it represents a definitely different meaning from the context. As used herein, expressions such as “A or B” or “at least one of A and/or B” may include all possible combinations of the items listed together therewith. Terms such as “first” or “second” may modify corresponding components regardless of order or importance and are used to distinguish one element from another, but do not limit the elements. It will be understood that, when an (e.g., first) element is referred to as being “connected to” another (e.g., second) element, the element may be directly connected to the other element or may be connected to the same via an intervening (e.g., third) element.

Hereinafter, embodiments will be described in detail with reference to the accompanying drawings, and in the description given with reference to the accompanying drawings, the same or corresponding components are assigned the same reference numerals, and a description thereof will not be repeated.

Embodiments of the present invention provide a hard floor structure 10 for a vehicle which is a structure using a hard material for a floor exposed on the rear surface in the interior of the vehicle.

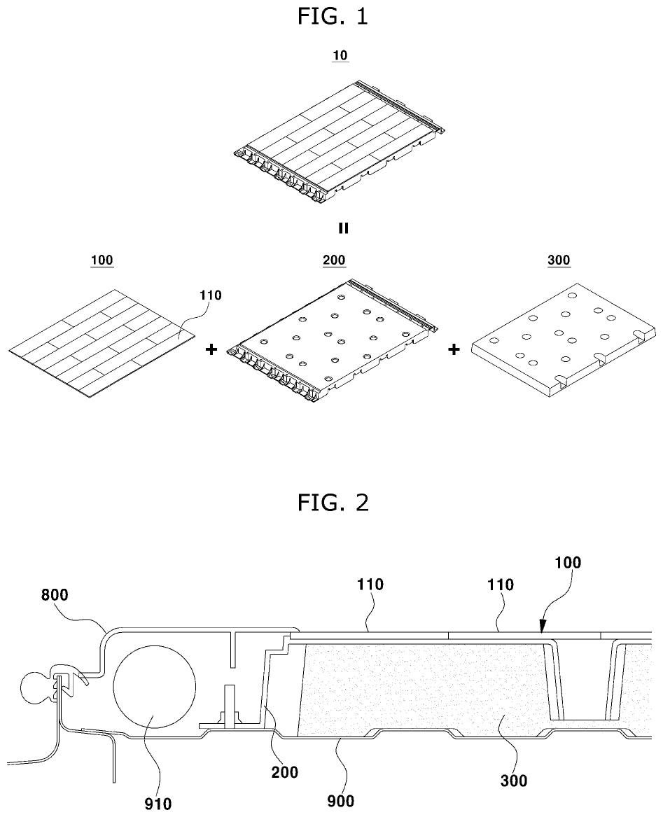

FIG. 1 illustrates how the hard floor structure 10 for a vehicle is constructed, as one embodiment of the present invention.

The hard floor structure 10 for a vehicle includes a bracket unit 200 located on a floor panel 900. The bracket unit 200 may be fixed to the floor panel 900 through welding or bolting. Further, the hard floor structure 10 includes a sound absorbing material 300 located between the bracket unit 200 and the floor panel 900. The sound absorbing material 300 is located under the bracket unit 200 by corresponding to the shape of the bracket unit 200 and is located between the floor panel 900 and the bracket unit 200. The sound absorbing material 300 may typically be made of poly-urethane (PU).

The hard floor structure 10 includes a hard cover unit 100 located on the upper surface of the bracket unit 200. The hard cover unit 100 may include one or more cover cells 110. The cover cells 110 may be provided as one block in the longitudinal direction of the vehicle or may be provided as one block in the lateral direction of the vehicle.

In one embodiment of the present invention, the plurality of cover cells 110 is fixed on the upper surface of the bracket unit 200 in the longitudinal direction of the vehicle. More specifically, the bracket unit 200 may include a plurality of brackets, and each of the cover cells 110 positioned on the upper surface of a corresponding one of the brackets may have the same orientation and size as each other.

The cover cell 110 of embodiments of the present invention may have printed thereon various types of patterns such as wood and marble or may be made of various materials. Further, a plurality of patterns on the cover cell 110 may be selected by a user.

The bracket unit 200 of embodiments of the present invention may be manufactured through an injection process, and the bracket unit 200 may be a combination of at least two or more brackets located at the front seat and the rear seat in the interior of the vehicle. More specifically, in one embodiment of the present invention, the bracket unit 200 may include a first bracket 210 located at a position corresponding to a driver seat, a second bracket 220 located at a position corresponding to a front passenger seat, a third bracket 230 located at a position corresponding to a passenger seat behind the driver seat, and a fourth bracket 240 located at a position corresponding to a passenger seat behind the front passenger seat. However, when the distinction between the driver seat and the front passenger seat is ambiguous in a vehicle performing autonomous driving, the bracket unit 200 may be divided into the first bracket 210 located at one side of the vehicle and the second bracket 220 located adjacent to another side of the vehicle with respect to the center of the vehicle.

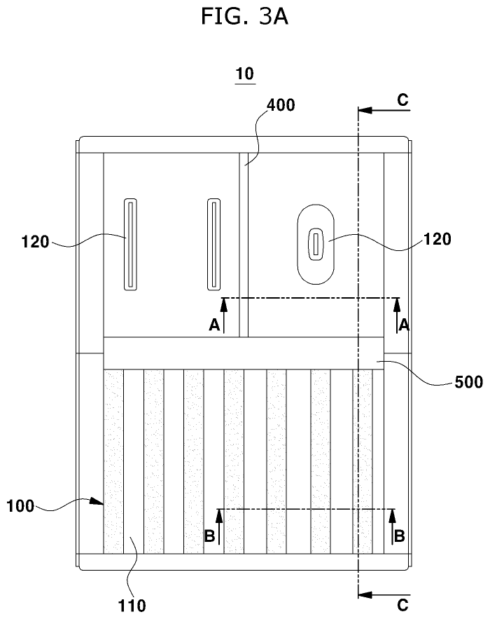

FIG. 2 is a cross-sectional side view of the vehicle interior including the hard floor structure 10 for the vehicle, as one embodiment of the present invention. In this embodiment, the hard cover unit 100 is exposed to an interior of the vehicle since there are no further structural elements between the hard cover unit 100 and the interior of the vehicle. It is understood that decorative materials such as carpet and mats, as examples, can overlie the hard cover unit.

As illustrated in the drawing, the hard floor structure 10 includes the bracket unit 200 fastened to the floor panel 900 constituting the interior lower surface of the vehicle. The hard floor structure 10 includes the sound absorbing material 300 located on the lower end of the bracket unit 200 and on the upper surface of the floor panel 900. Further, the bracket unit 200 has an upper surface including the hard cover unit 100, which includes one or more cover cells 110.

The floor structure may have opposite side ends each having a vehicle door located thereat, and the floor panel 900 may have opposite ends each having a vehicle door located thereat and including a door scuff 800. The door scuff 800 may cover at least a portion of the upper surface of the hard cover unit 100. In addition, the door scuff 800 has an inner side including a wiring 910 portion positioned along the floor in the longitudinal direction of the vehicle.

The floor panel 900 may have an upper surface including a bolt structure fastened to the end of the bracket unit 200. More specifically, a plurality of brackets may have an overlapping area and the overlapping area may be fastened to one bolt structure.

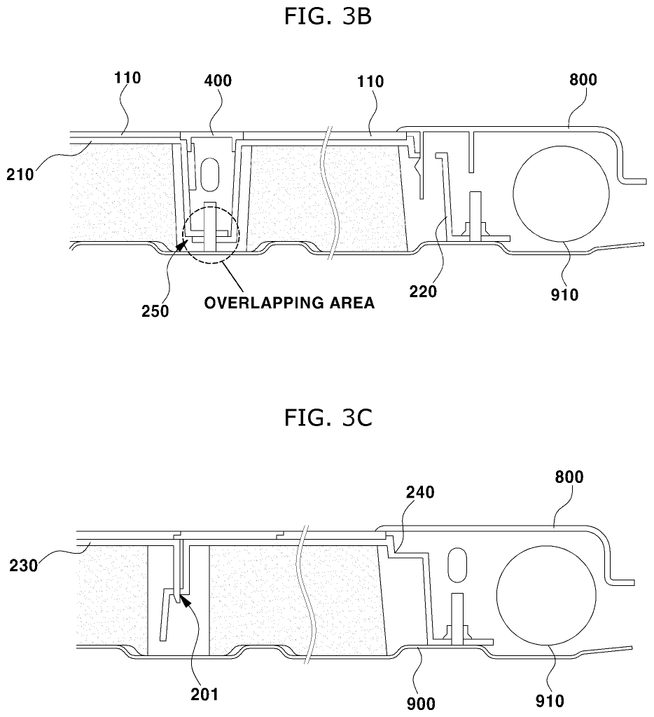

FIG. 3A is a top view of the vehicle interior including the hard cover unit 100 as one embodiment of the present invention which illustrates each area where the first bracket 210 to the fourth bracket 240 are located.

As illustrated in the drawing, the hard cover unit 100 may be divided with respect to the front seat and the rear seat. Specifically, the hard cover unit 100 may be divided with respect to one end close to the driver seat (right end or left end) and another end close to the passenger seat (another end opposite the one end where the driver seat is located) in the lateral direction of the vehicle. More specifically, the driver seat and the front passenger seat may be divided with respect to a center molding 400, and the front seat and the rear seat may be divided with respect to an end cover 500.

As described above, the hard cover unit 100 of embodiments of the present invention, including the division of the front seat, the rear seat, the driver seat, and the front passenger seat, may have a lower end having located thereat the bracket unit 200, which also includes divisions.

Specifically, the bracket unit 200 may be divided into the first bracket 210 provided at a region where the driver seat is located, the second bracket 220 provided at a region where the front passenger seat is located, the third bracket 230 provided at a region where a rear seat behind the driver seat is located, and the fourth bracket 240 provided at a region where a rear seat behind the front passenger seat is located.

As illustrated in FIG. 3B, referring to cross section A-A of FIG. 3A, because the first bracket 210 is assembled after the second bracket 220 is positioned, an area where one end of the first bracket 210 and one end of the second bracket 220 overlap is created, and thus the first bracket 210 and the second bracket 220 are integrally fixed to the bolt structure, protruding through the overlapping area from the floor panel 900. In other words, the second bracket 220 is first positioned on the upper surface of the floor panel 900, and then at least a portion of the first bracket 210 is assembled to include an overlapping area positioned on the second bracket 220. Thereafter, the floor panel 900, the first bracket 210, and the second bracket 220 are integrally fixed via a single bolt structure.

The first bracket 210 and the second bracket 220 may include a center groove 250 provided therebetween and the center molding 400 inserted into the center groove 250. More specifically, in one embodiment of the present invention, because the center molding 400 has at least a portion inserted into the center groove 250 formed between the first bracket 210 and the second bracket 220, the upper surface of the center molding 400 may be level with the upper surface of the hard cover unit 100.

FIG. 3C illustrates a cross section B-B of FIG. 3A, as one embodiment of the present invention. In the drawing, coupling between the third bracket 230 and the fourth bracket 240 provided at the rear seat is illustrated.

In one embodiment of the present invention, the fourth bracket 240 is first fixed to the upper surface of the floor panel 900, and then at least a portion of the end of the third bracket 230 is fixedly inserted into a mutual fixing portion 201 positioned at the fourth bracket 240.

More specifically, the first bracket 210, the second bracket 220, the third bracket 230, and the fourth bracket 240 each may include the mutual fixing portion 201 formed at a position where the same are facing each other so that one end of a bracket adjacent thereto is fixedly inserted thereinto. Accordingly, the upper surfaces of the first bracket 210, the second bracket 220, the third bracket 230, and the fourth bracket 240 that are mutually fastened via the mutual fixing portion 201 may have a completely flat shape without gaps by the cover cell 110.

In other words, as an embodiment of the present invention, because a bracket may have one end fixedly inserted into the mutual fixing portion 201 formed in a bracket adjacent thereto, a mutually fixed state between the brackets in the bracket unit may be maintained, and the cover cell 110 may be positioned such that the upper surfaces of the brackets fastened to each other maintain a flat plate shape.

In other words, because the fourth bracket 240 is first fastened to the floor panel 900 and then the third bracket 230 is assembled to the upper surface of the floor panel 900, at least a portion of the third bracket 230 may be fixedly inserted into the fourth bracket 240.

FIG. 3D is a longitudinal cross-sectional view of the floor taken along a line C-C of FIG. 3A, as one embodiment of the present invention.

As illustrated in the drawing, the fourth bracket 240 has at least one end fixed to the floor panel 900 while overlapping at least a portion of the end of the second bracket 220. In addition, the fourth bracket 240 and the second bracket 220 have the end cover 500 located therebetween. Moreover, the end cover 500 has a lower end at which the fourth bracket 240 is located, and the fourth bracket 240 has a lower end having the wiring 910 portion provided in the lateral direction of the vehicle.

Because the end cover 500 is inserted into an end groove 260 formed between the second bracket 220 and the fourth bracket 240, the upper surface of the end cover 500 is level with the upper surface of the hard cover unit 100 located on the upper surfaces of the second bracket 220 and the fourth bracket 240.

As such, because the second bracket 220 is first assembled to the floor panel 900 and then the fourth bracket 240 is assembled, at least a portion of the fourth bracket 240 overlaps at least a portion of the second bracket 220. Moreover, the second bracket 220 and the fourth bracket 240 overlapping each other may be fixed to the floor panel 900 via one bolt structure located at the floor panel 900.

Further, because the first bracket 210 and the third bracket 230 may be integrally fixed to the floor panel 900, the first bracket 210 is brought into contact with the floor panel 900 and the third bracket 230 has at least a portion brought into contact with a position where the first bracket 210 is in contact with the floor panel 900. Accordingly, the first bracket 210 and the third bracket 230 may be integrally fastened to the bolt structure of the floor panel 900.

Referring to FIGS. 3A to 3D, as an assembly sequence of the bracket unit 200 to construct the hard floor structure 10 for a vehicle, the second bracket 220 is fastened to the floor panel 900 first, the first bracket 210 is fixed to the floor panel 900, and then the fourth bracket 240 and the third bracket 230 are sequentially fixed to the floor panel 900. Accordingly, there may be created an overlapping area in which the second bracket 220 and the first bracket 210 overlap each other and an overlapping area in which the fourth bracket 240 and the second bracket 220 overlap each other, and each of the overlapping areas may be integrally fixed to the floor panel 900. Further, because the third bracket is located on the floor panel 900 after the fourth bracket 240 is fixed to the floor panel 900, at least a portion of the third bracket 230 may be fixedly inserted into the fourth bracket 240.

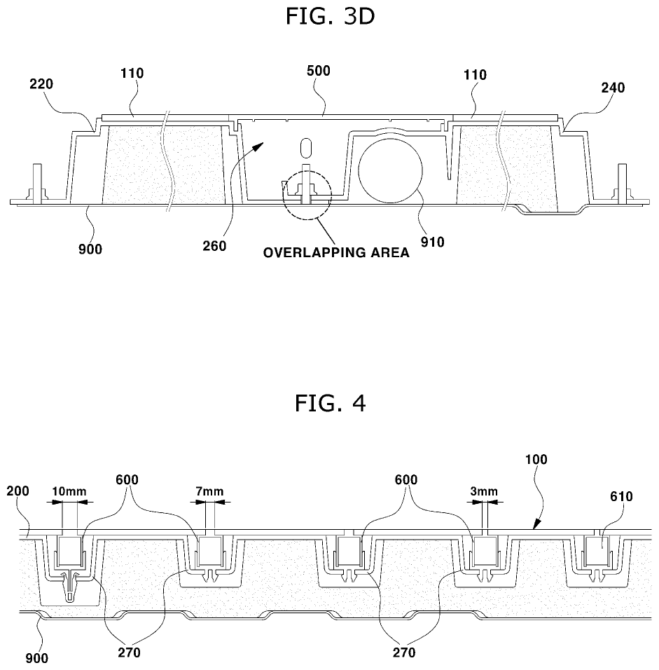

FIG. 4 illustrates the hard cover unit 100 including a lamp unit 600, as one embodiment of the present invention.

The floor panel 900 has an upper end having the sound absorbing material 300 located thereat, and the bracket unit 200 covers the sound absorbing material 300. The bracket unit 200 includes at least one groove portion 270 formed between the cover cells 110 constituting the hard cover unit 100. The groove portion 270 has an inner side provided with one or more lamp units 600. The lamp unit 600 is inserted into the groove portion 270 formed in the bracket unit 200 in a horizontal direction according to the arrangement of the cover cells 110.

Further, depending on the lamp unit 600 inserted into the groove portion 270, each gap between the cover cells 110 may be different from each other according to a set value. Accordingly, light emitted from the lamp unit 600 may pass through the gap between the cover cells 110. Moreover, the gap through which the upper surface of the lamp unit 600 is exposed is determined by at least a portion of the hard cover unit 100 positioned thereon.

In one embodiment of the present invention, the gap between the cover cells 110 through which the lamp unit 600 emits light may be 3 mm to 10 mm.

Further, because the cover cell 110 has a lower surface provided with one or more pressure sensors 610, when a pressure equal to or greater than a reference value is applied to the pressure sensor 610, power is applied to the lamp unit 600 to emit light.

In one embodiment of the present invention, the pressure sensor 610 may have a corresponding cover cell 110 positioned thereon, and when a pressure equal to or greater than a reference value is applied to the corresponding cover cell 110, the lamp unit 600 adjacent to the corresponding cover cell 110 may emit light.

In still another embodiment, the pressure sensor 610 may be installed at the lower end of a cover cell 110 located at a corresponding one of opposite ends each being adjacent to the door, and when a pressure equal to or greater than a reference value is applied to the corresponding cover cell 110, the lamp unit 600 may be turned on in response to a welcome mode.

Further, the lamp units 600 each being located at a corresponding cover cell 110 may have an LED having a color different from each other, and when an operation request on the lamp unit 600 is applied from the pressure sensor 610, the lamp units 600 each located at a corresponding cover cell 110 may be controlled to be sequentially turned on. In addition, the lamp units 600 having different colors may be sequentially turned on or at least partially turned on simultaneously according to a set order.

As such, the lighting method of the lamp unit 600 disclosed in embodiments of the present invention is driven by the set value, and the lighting method and lighting type are not limited by this specification.

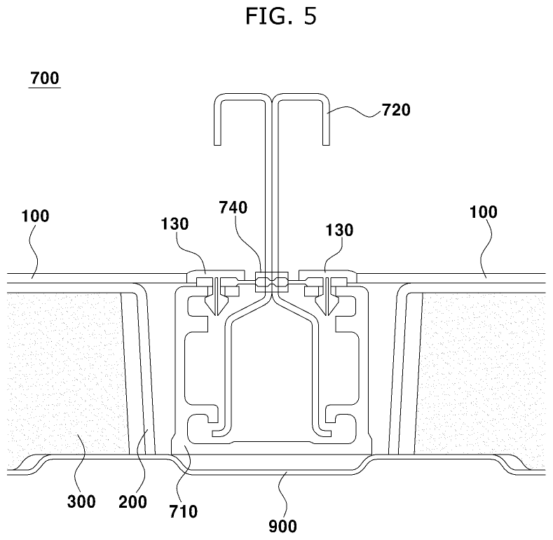

FIG. 5 is a cross-sectional view of a seat rail unit 700 including a pair of lower rails 710, as one embodiment of the present invention.

As illustrated in the drawing, the seat rail unit 700 has a lower end fixed to the floor panel 900 and includes the pair of lower rails 710 provided in the longitudinal direction of the vehicle. The seat rail unit 700 includes an upper rail 720 having at least a portion positioned at the lower rail 710 and protruding outwardly of a transfer groove 120 in the hard cover unit 100 so as to move along the lower rail 710.

The transfer groove 120 includes a movement trajectory along which the upper rail 720 and the seat are integrally moved in the longitudinal direction of the floor of the vehicle. More specifically, the seat rail unit 700 includes a cover portion 130 configured to cover the upper end portion of the transfer groove 120 along the movement trajectory of the upper rail 720 moving along the transfer groove 120.

The cover portion 130 may cover the open groove of the transfer groove 120 along the movement trajectory of the rear end of the upper rail 720, and may open the transfer groove 120 along the movement trajectory of the front end of the upper rail 720. In addition, the cover portion 130, positioned adjacent to the transfer groove 120 and configured to open or cover the transfer groove 120, may be made of fabric.

More specifically, the seat rail unit 700 includes a slider 740 positioned at the rear end of the upper rail 720, and toothed structures provided on the cover portion 130 adjacent to the transfer groove 120 may be engaged with each other as the slider 740 is moved.

In addition, the slider 740 positioned at the front end of the upper rail 720 may separate the toothed structures provided on opposite sides of the cover portion 130 with respect to the transfer groove 120 from each other to thereby open the transfer groove 120 located in the movement trajectory of the upper rail 720.

As such, the cover portion 130 of embodiments of the present invention includes toothed structures corresponding to the slider 740 integrated with the front and rear ends of the upper rail 720, and the cover portion 130 adjacent to the transfer groove 120 is opened and closed corresponding to the movement direction of the slider 740 so that the transfer groove 120 is not exposed to the outside.

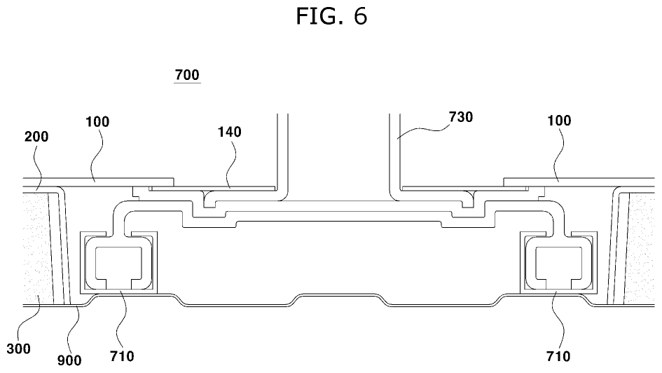

FIG. 6 illustrates a monopost rail 730 structure including a single neck located at a pair of lower rails 710, as another embodiment of the present invention.

As another embodiment of the present invention, a seat rail unit 700 includes a pair of lower rails 710 fixed to a floor panel 900. In addition, the lower rails 710 include the monopost rail 730 configured to move along the lower rails 710 provided in the longitudinal direction of the vehicle or at a predetermined angle with the longitudinal direction. The monopost rail 730 may have one end fastened to the pair of lower rails 710 and may move along a transfer groove 120 in a hard cover unit 100 by including a single neck. More specifically, the monopost rail 730 may have a single neck protruding outwardly of the hard cover unit 100 in the height direction of the hard cover unit 100.

Further, the monopost rail 730 includes a covering 140 located at the lower end of the hard cover unit 100 and configured to move integrally with the monopost rail. The covering 140 may be relatively larger than the transfer groove 120 in the hard cover unit 100. Therefore, when the monopost rail moves along the lower rails 710, the transfer groove 120 may always be covered by the covering 140.

As such, according to one embodiment and another embodiment of the present invention, the seat rail unit 700 protrudes outwardly of the hard cover unit 100 in the height direction of the hard cover unit 100 so as to move integrally with the seat, and thus may include the upper rail 720 or the monopost rail 730.

Further, the transfer groove 120 formed in the hard cover unit 100 may always be covered by the cover portion 130 or the covering 140. Accordingly, introduction of dust or dirt into the transfer groove 120 may always be blocked.

As is apparent from the above description, embodiments of the present invention provide the following effects.

Embodiments of the present invention provide an interior environment of a vehicle capable of providing sufficient rigidity via a hard floor structure for a vehicle having a flat floor including a hard cover unit.

In addition, embodiments of the present invention provide support rigidity sufficient for the load applied to the floor via various bracket structures configured to support the hard cover unit.

Moreover, embodiments of the present invention provide the hard cover unit including a plurality of cover cells, thereby improving aesthetics of the interior of the vehicle.

The detailed description is merely illustrative of embodiments of the present invention. In addition, the above description shows and describes preferred embodiments of the present invention, but embodiments of the present invention can be used in various other combinations, modifications, and environments. That is, changes or modifications are possible within the scope of the idea of the invention disclosed herein, the scope of equivalents to the described invention, and/or the scope of skill or knowledge in the art. The embodiments describe the best state for implementing the technical idea of the present invention, and various changes required for specific application fields and uses of embodiments of the present invention are possible. Therefore, the detailed description of embodiments of the present invention is not intended to limit the present invention to the disclosed embodiments. Also, the appended claims should be construed to include other embodiments.

What is claimed is:

1. A hard floor structure for a vehicle, the structure comprising:
a bracket unit fastened to a floor panel; and
a hard cover unit on the bracket unit, the hard cover unit being exposed to an interior of the vehicle and having a plate shape.

2. The structure according to claim 1, wherein the hard cover unit comprises a combination of a plurality of cover cells.

3. The structure according to claim 2, further comprising a lamp unit inserted into a groove in the bracket unit, wherein a portion of the lamp unit is exposed through a gap between the plurality of cover cells.

4. The structure according to claim 3, wherein a portion of the hard cover unit covers an upper end of the lamp unit.

5. The structure according to claim 3, wherein at least one cover cell of the plurality of cover cells comprises a pressure sensor configured to drive the lamp unit.

6. The structure according to claim 1, wherein a portion of an upper surface of the hard cover unit is positioned to overlap a door scuff.

7. The structure according to claim 1, further comprising a sound absorbing material between the bracket unit and the floor panel.

8. A hard floor structure for a vehicle, the structure comprising:
a bracket unit fastened to a floor panel, the bracket unit comprising:
a first bracket in a region corresponding to a driver seat;
a second bracket in a region corresponding to a front passenger seat;
a third bracket in a region corresponding to a passenger seat behind the driver seat; and
a fourth bracket in a region corresponding to a passenger seat behind the front passenger seat; and
a hard cover unit on the bracket unit, the hard cover unit being exposed to an interior of the vehicle and having a plate shape.

9. The structure according to claim 8, wherein portions of the first bracket and the second bracket overlap each other at a position where the portions are fastened to the floor panel.

10. The structure according to claim 8, wherein one of the first bracket, the second bracket, the third bracket, or the fourth bracket has one end fixedly inserted into a mutual fixing portion of an adjacent one of the first bracket, the second bracket, the third bracket, or the fourth bracket.

11. The structure according to claim 8, wherein portions of the first bracket and the third bracket overlap each other at a position where the portions are fastened to the floor panel.

12. The structure according to claim 8, wherein portions of the second bracket and the fourth bracket overlap each other at a position where the portions are fastened to the floor panel.

13. The structure according to claim 8, wherein the hard cover unit further comprises a center molding inserted into a center groove between the first bracket and the second bracket.

14. The structure according to claim 8, wherein the hard cover unit further comprises an end cover inserted into an end groove between the first bracket and the second bracket located at a front seat and the third bracket and the fourth bracket located at a rear seat.

15. The structure according to claim 8, further comprising a sound absorbing material between the bracket unit and the floor panel.

16. A hard floor structure for a vehicle, the structure comprising:
a bracket unit fastened to a floor panel;
a hard cover unit on the bracket unit, the hard cover unit being exposed to an interior of the vehicle and having a plate shape; and
a seat rail unit fixed to the floor panel and protruding through an upper end of the hard cover unit.

17. The structure according to claim 16, wherein the seat rail unit comprises:
a lower rail fixed to the floor panel;
an upper rail having a end positioned in the lower rail and a second end protruding through the hard cover unit in a height direction of the hard cover unit, the upper rail being configured to move along a longitudinal transfer groove in the hard cover unit; and
a cover portion on the hard cover unit and configured to cover the transfer groove along a movement trajectory of the upper rail.

18. The structure according to claim 16, wherein the seat rail unit comprises:
a lower rail fixed to the floor panel;
a monopost rail having a first end positioned in the lower rail and a second end protruding through the hard cover unit in a height direction of the hard cover unit, the monopost rail being configured to move; and
a covering on a rear surface of the hard cover unit and configured to move integrally with the monopost rail.

19. The structure according to claim 16, wherein an upper surface of the hard cover unit is positioned to overlap a door scuff.

20. The structure according to claim 16, further comprising a sound absorbing material positioned between the bracket unit and the floor panel.
